(19) United States
(12) Patent Application Publication
(10) Pub. No.: US 2004/0253003 A1
(43) Pub. Date: Dec. 16, 2004

(54) Gain compensating optical receiver circuit

(75) Inventors: James O. Farmer, Alpharetta, GA (US); John J. Kenny, Suwanee, GA (US); Earl Anthony Daughtry, Alpharetta, GA (US); Daniel M. LaGesse, Dunwoody, GA (US)

Correspondence Address: KING & SPALDING LLP, 191 PEACHTREE STREET, N.E., ATLANTA, GA, 30303-1763, US

(73) Assignee: Wave 7 Optics, Inc., Alpharetta, GA

(21) Appl. No.: 10/746,407

(22) Filed: Dec. 24, 2003

Related U.S. Application Data
(63) Continuation-in-part of application No. 09/899,410, filed on Jul. 5, 2001.
(60) Provisional application No. 60/436,843, filed on Dec. 27, 2002.

(51) Int. Cl. H04B 10/06

(52) U.S. Cl. 398/214

(57) ABSTRACT

An optical receiver circuit receives analog optical signals and outputs corresponding electrical signals. The circuit's amplifier can amplify a modulated signal from a photodiode. Gain control can adjust the amplifier's gain to compensate for power fluctuation in the optical signals. Linear compensation can enhance the linearity of the gain adjustment in response to optical power fluctuation and can facilitate feedforward gain control. A digital controller can implement the linear compensation. The circuit can operate with an impedance mismatch in the coupling between the photodiode and the amplifier, thereby avoiding the need for an impedance matching transformer in that coupling.

### CROSS REFERENCE TO RELATED APPLICATIONS

This application claims the benefit of priority as a continuation-in-part of U.S. Nonprovisional Ser. No. 09/899,410 entitled “System and Method for Communicating Optical Signals between a Data Service Provider and Subscribers” filed Jul. 5, 2001 and to U.S. Provisional Patent Application Ser. No. 60/436,843 entitled “Improved Broadcast Optical Receiver” filed Dec. 27, 2002. The subject matter of both the U.S. Nonprovisional and U.S. Provisional Patent Application No. 60/436,843 is hereby fully incorporated by reference.

### TECHNICAL FIELD

The present invention relates to receiving optical communications signals and more specifically to receiving analog optical signals with electrical circuits that provide gain control.

### BACKGROUND OF THE INVENTION

Today's fiber optic network technology facilitates cost-effective transmission of large quantities of analog and digital information between major information hubs. In other words, conventional fiber optic networks provide substantial bandwidth service between locations that have high-bandwidth needs. Long-haul fiber optic links provide high-speed communication between metropolitan areas. Within each metropolitan area, a fiber optic network typically connects information centers to one another or to a central information hub.

Each access point on these metropolitan and long-haul fiber optic networks typically serves numerous users. Thus, a large quantity of information, or bandwidth, flows onto and off of the optical network at each access point. Light carries information on the optical network side of each access point, while electrical signals carry information between each access point and the numerous users that it serves.

To supply the bandwidth needs of multiple users, each access point is typically collocated with electrical systems that aggregate the electrical communication signals to and from numerous users. Each access point also includes two interfaces that bridge between the optical domain of the optical network and the electrical domain of the user. An electrical-to-optical interface receives electrical signals from the users and generates corresponding optical signals for transmission over the optical network. An optical-to-electrical interface receives optical signals from the network and generates corresponding electrical signals for transmission to the users.

With the electrical and optical hardware at each access point serving numerous users, each user effectively incurs only a small fraction of the total cost of the interface hardware. Consequently, stringent cost requirements do not constrain the electrical and optical hardware of these high-capacity access points. That is, the economics of high-capacity access justify complex, expensive hardware.

The economic justifications of high-capacity access contrast with the cost constraints associated with fiber optic networks that provide optical communication services to users having relatively small communication bandwidth needs. The fiber-to-the-home (“FTTH”) application of fiber optic technology represents a trend towards extending fiber optic networks towards end users. Each access point on a FTTH optical network accesses a relatively small increment of bandwidth, typically a single household. The cost and complexity of the access systems through which individual users tap into a fiber optic infrastructure is generally regarded as a limiting factor in extending optical fiber networks to serve individual households. The conventional technologies that underlie high-bandwidth access systems are generally incompatible with the cost constraints of FTTH. Reducing cost and complexity in these systems and their underlying technologies would facilitate providing individual households with optical data, optical voice, and optical video services on a broader scale than is viable with conventional technology.

Optical-to-electrical interface hardware represents a significant cost and complexity of conventional access systems; thus, specifically addressing its cost and complexity serves FTTH applications. A considerable portion of the cost and complexity of a conventional access system typically resides in the receiver circuit that accepts fiber optic signals and outputs corresponding electrical signals. Conventional receivers generally include a complicated amplifier circuit that maintains the output electrical signals at a stable power level. One complexity of this circuit is a conventional control scheme that adjusts amplifier gain to provide consistent output power. Conventional receiver amplifiers often exhibit nonlinear amplification, or gain, characteristics. In other words, under certain conditions, a change in input can result in a disproportionate and troublesome change in output. Conventional receiver circuits usually address this nonlinearity by monitoring the output and adjusting the amplifier with a complicated scheme known as closed loop feedback control. Also, conventional receiver output can be susceptible to temperature fluctuations in the receiver's operating environment.

Furthermore, conventional receiver circuits usually require special provisions to couple standard electrical components, which receive and output electrical signals, to optoelectronic components, which receive light and output electrical signals. More specifically, a photodiode is generally a current source, which outputs a specific current somewhat independent of resistive load, while an amplifier is generally a voltage device. That is, photodiodes and the electrical amplifiers to which they couple have inherently different electrical-coupling, or impedance, characteristics. Conventional receiver circuits typically do not perform adequately if such impedance mismatch exists within the circuit. In other words, impedance mismatch is typically incompatible with conventional receivers. One conventional approach to this impedance matching problem is the insertion of an impedance matching element, such as a wire-wound transformer, between the photodiode and the amplifier. However, impedance matching transformers tend to introduce complications and disadvantages to the circuit. Among the disadvantages, transformers consume signal power, degrade the frequency response, dissipate heat, contribute expense, and add bulk.

To address these representative deficiencies in the conventional receiver art, what is needed is a capability for receiving analog optical signals with cost-effective circuitry that linearly compensates for optical power fluctuation and environmental influences. Further, a receiver circuit is needed that provides adequate performance with impedance mismatch in the coupling between a photodiode and an amplifier and does not require a transformer in this coupling. Such a capability would facilitate providing cost effective optical communication services to end user.

### SUMMARY OF THE INVENTION

The present invention supports receiving analog optical signals and generating corresponding electrical signals using cost-effective circuitry. In one aspect of the present invention, the receiving circuitry can include a photodiode and an amplifier. An optical waveguide, such as an optical fiber in an optical network, can deliver the analog optical signal to the photodiode. The analog optical signal can include a base level that may fluctuate over time due to variations in the optical network, or other influences. The analog optical signal can also include an optical signal that is the carrier of information and that intentionally and rapidly oscillates. That is, the analog optical signal can have a bias component, which can drift, and a modulated component, which changes in a specified pattern that defines its information content. The photodiode can generate an electrical signal that includes an electrical bias signal, or base level, and a modulated signal corresponding to the optical bias signal and the optical modulated signal respectively. The amplifier can increase the strength, or amplitude, of this modulated electrical signal so that signal processing equipment can readily process the signal and access its information content.

In another aspect of the present invention, the receiving circuit can include an amplification provision that maintains the strength of the output modulated electrical signal at a consistent level. That is, the receiving circuit can include control circuitry that compensates for changes in the power of the incoming optical signals by adjusting the degree of amplification. By applying more amplification when the incoming optical signals are weak than when they are strong, the control circuit can automatically respond to changing conditions in the communication network that affect signal intensity.

In another aspect of the present invention, the amplification control circuit can correct for nonlinearity in the amplifier gain control function. Amplifiers can be described as having a gain, which can be the ratio of output intensity, or output signal level, to input intensity, or input signal level. An amplifier of the present invention can have a gain that can be varied or controlled by a gain control voltage. The purpose of the variable gain control can be to keep the output signal intensity constant as the input signal intensity changes. The amplifier and gain control voltage can be arranged such that as the input signal intensity increases, the gain of the amplifier decreases, the net result being that the output level remains at a consistent level.

When the gain of an amplifier is directly proportional to the magnitude of the gain control voltage, the amplifier gain control can be considered linear. Deviation from such direct proportionality can be considered nonlinearity. Amplifier gain control in the present invention can include linearity compensation or correction. This linearity compensation can improve the linearity, predictability, and stability of the amplifier's response within a range of input intensities. Also, linearity compensation can extend the range of input intensities over which the amplifier exhibits acceptably linear amplification, without overload. Implementing linear compensation can include adjusting the attenuation of an attenuator, variable resistance, or other device that suppresses gain associated with the amplifier.

In yet another aspect of the present invention, linearity compensation of amplifier gain can include a digital implementation. The linearity compensation can include digitally representing one or more electrical signals related to the amplification process. The digital representation can be an analog-to-digital (“A/D”) conversion of the bias electrical signal, or another signal that describes the intensity of the input optical signal. Digital logic, such as a microprocessor, a microcontroller, or hardwired digital logic, can process the digital representation and compute an amplification adjustment. A lookup table or similar file in read-only-memory (“ROM”) can store computational instructions and/or numbers associated with the computation. A digital-to-analog conversion of the computational output can yield an analog control signal, such as a control voltage. The circuit can feed this control voltage to a variable attenuator associated with the amplifier which can actuate the attenuation correction.

In yet another aspect of the present invention, the receiver circuit can control the amplifier with feedforward control. The receiver circuit can split the electrical signal corresponding to the input optical signal, which the photodiode outputs, into a bias electrical signal and a modulated electrical signal. The amplifier can amplify the modulated electrical signal, and the receiver circuit can control the amplifier based on the bias electrical signal. An amplifier control circuit within the receiver circuit can generate an amplifier control signal by manipulating the bias electrical signal. That is, the amplifier control circuit can increase the amplification, or amplifier gain, if the bias electrical signal strength decreases and decrease the gain if the bias electrical signal strength increases. The feedforward control can include linear compensation.

In yet another aspect of the present invention, the receiver circuit can operate well with an impedance mismatch in the circuit. Impedance can be measurement of the load, or relationship between current and voltage, that a circuit component inherently applies to a modulated signal propagating in the circuit. The impedance of a photodiode and the impedance of an amplifier can be significantly different, or mismatched. If the impedances of two components that are coupled together in a circuit are not similar and the circuit does not include an impedance matching element, such as a transformer in the coupling, the circuit can be said to be impedance mismatched. The receiver circuit can achieve acceptable performance without a transformer or other impedance matching element in the coupling between the photodiode and the amplifier.

The discussion of optical receivers presented in this summary is for illustrative purposes only. Various aspects of the present invention may be more clearly understood and appreciated from a review of the following detailed description of the disclosed embodiments and by reference to the drawings and claims.

### BRIEF DESCRIPTION OF THE DRAWINGS

FIGS. 1A and 1B are functional block diagrams illustrating an optical network according to an exemplary embodiment of the present invention.

FIG. 2 is a functional block diagram illustrating an analog optical receiver according to an exemplary embodiment of the present invention.

FIG. 3 illustrates a schematic representation of an analog optical receiver circuit with an impedance matching transformer and feedforward gain control according to an exemplary embodiment of the present invention.

FIG. 4 illustrates a schematic representation of an analog optical receiver circuit with linear feedforward gain control of a two-stage amplifier according to an exemplary embodiment of the present invention.

FIG. 5 illustrates a schematic representation of an analog optical receiver circuit with feedback gain control of a two-stage amplifier according to an exemplary embodiment of the present invention.

FIG. 6 illustrates a schematic representation of an analog optical receiver circuit with linear feedforward gain control of a single-stage amplifier according to an exemplary embodiment of the present invention.

FIG. 7 illustrates a schematic representation of an analog optical receiver circuit with feedback gain control of a single-stage amplifier according to an exemplary embodiment of the present invention.

FIG. 8 illustrates a schematic representation of an analog optical receiver circuit with gain control according to an exemplary embodiment of the present invention.

FIG. 9 is a functional block diagram of a digital linearity compensation component that facilitates linear gain control of an amplifier according to an exemplary embodiment of the present invention.

FIGS. 10A and 10B illustrate an analog linearity compensation component that facilitates linear gain control of an amplifier according to an exemplary embodiment of the present invention.

FIG. 11 illustrates a process for receiving analog optical signals according to an exemplary embodiment of the present invention.

### DETAILED DESCRIPTION OF EXEMPLARY EMBODIMENTS

The present invention is directed to cost-effective receiver circuitry that receives analog optical signals from an optical waveguide, such an optical fiber, and outputs corresponding electrical signals that have consistent intensity despite fluctuations in the intensity of the optical signals. Such receiver circuitry serves extending optical networks to individual users who have incremental bandwidth needs. The users can access an optical network for voice, data, video, and other communication services.

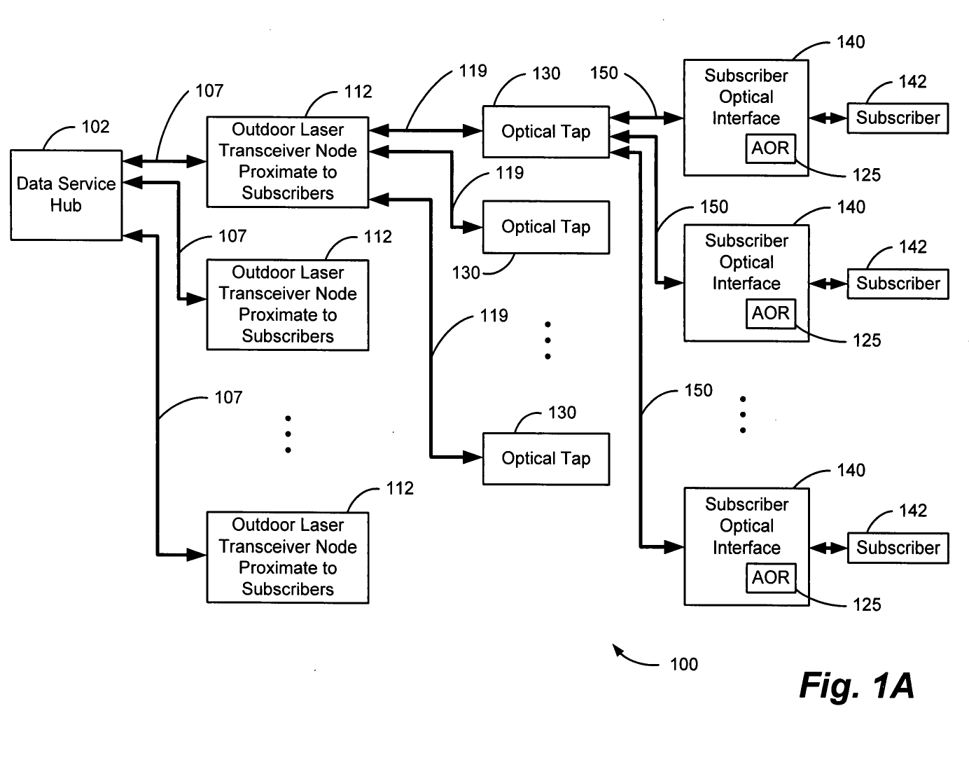

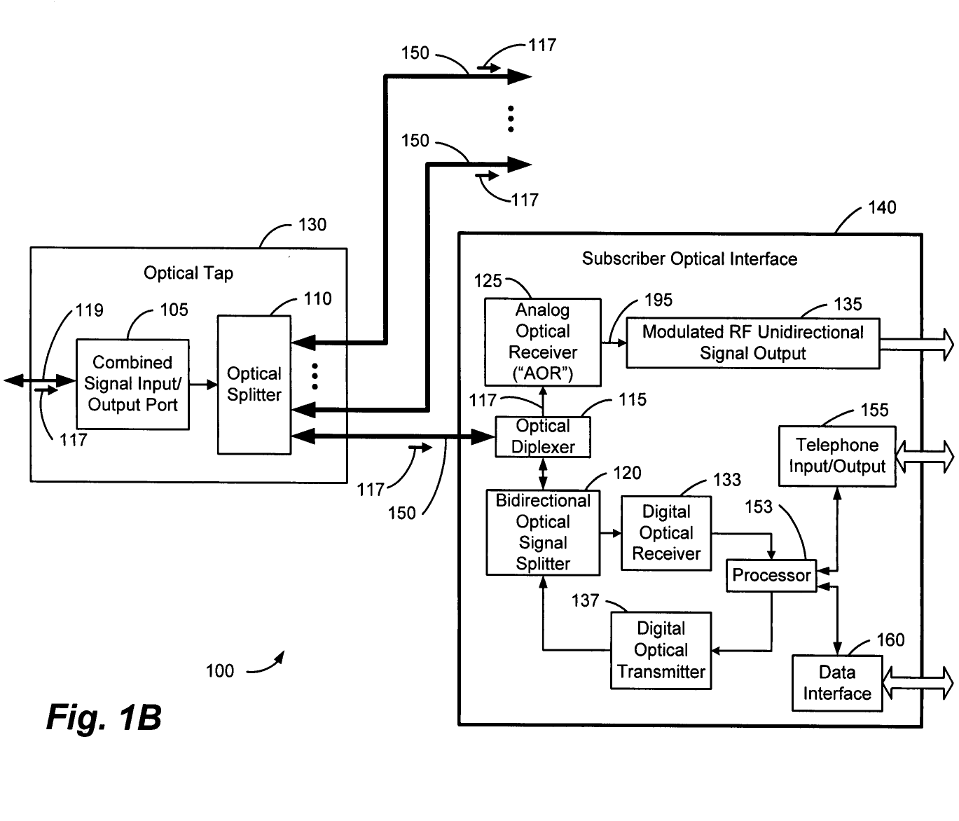

Turning now to discuss each of the drawings presented in FIGS. 1-11, in which like numerals indicate like elements throughout the several figures, an exemplary embodiment of the present invention will be described in detail.

Referring now to FIGS. 1A and 1B, these Figures are functional block diagrams illustrating an optical network 100 according to an exemplary embodiment of the present invention. The illustrated optical network 100 provides voice, video, digital television, data, and related services to subscribers and can be a FTTH network, a fiber-to-the-business (“FTFB”) network, or a fiber-to-the-curb (“FTTC”) network.

A data service hub 102, on the upstream side of the optical network 100, offers voice, data, and video services to subscribers 142 over the optical network 100. Among the data service hub's typical components (not shown) are an Internet router, a telephone switch, and a video modulation system. The video modulation system broadcasts optically modulated video signals in the downstream direction over the optical network 100. In other words, the optical network 102 distributes optical video signals generated in the data service hub 102 to the subscribers 142.

Further details of the optical network 100 and data service hub 102 are described in U.S. Nonprovisional Patent Application No. 09/899,410 entitled “System and Method for Communicating Optical Signals between a Data Service Provider and Subscribers” filed Jul. 5, 2001, the entire contents of which are hereby incorporated by reference.

In one embodiment of the present invention, the data service hub 102 is the headend of cable television distribution system. The data service hub 102 transmits and receives information from a plurality of outdoor laser transceiver nodes 112 that are physically proximate to the subscribers 142 that it serves. Each outdoor laser transceiver node 112 has a dedicated optical communication link 107 to the data service hub 102. Each of these optical communication links 107 contains multiple optical waveguides.

The outdoor laser transceiver nodes 112 adjust subscriber bandwidth on a subscription or as-needed basis to provide the subscribers 142 with incremental bandwidth allotments. Alternatively, subscribers 142 can receive bandwidth from an outdoor laser transceiver node 112 in pre-assigned increments. Each outdoor laser transceiver node 112 communicates with a plurality of optical taps 130 via a dedicated distribution optical waveguide 119.

Each optical tap 130 couples a plurality of drop optical waveguides 150 to the distribution optical waveguide 119, with each drop optical waveguide 150 serving a dedicated subscriber optical interface 140. Each optical tap 130 includes a combined signal input/output port 105 that provides the connection to the outdoor laser transceiver node 112 via a distribution optical waveguide 119. The optical tap 130 also includes an optical splitter 110 such as a four-way or eight-way optical splitter 110. The optical splitter 110 processes both upstream optical signals, which propagate from the subscribers 142, and downstream optical signals, which propagate towards the subscribers 142. The optical splitter 110 divides downstream optical signals propagating in the distribution optical waveguide 119 among the drop optical waveguides 150. The optical splitter 130 also aggregates upstream optical signals from the drop optical waveguides 150 for propagation in the distribution optical waveguide 119.

The optical tap 130 is an efficient coupler that communicates optical signals between the outdoor laser transceiver node 112 and its respective subscriber optical interfaces 140. In one exemplary embodiment, the optical tap 130 is a 4-way optical tap of the pass-through type, meaning a portion of the downstream optical signals is extracted or divided to serve a 4-way splitter contained therein, while the remainder of the optical energy is passed further downstream. In one embodiment, the optical taps 130 are disposed in a cascade layout, such as a daisy chain configuration. Alternatively, the optical taps 130 can be arranged in a star configuration.

Each optical tap 130 can connect to a limited or small number of optical waveguides so that high concentrations of optical waveguides are not present at any individual laser transceiver node 112. In other words, in one exemplary embodiment, each optical tap 130 connects to a limited number of optical waveguides 150 at a point remote from the outdoor laser transceiver node 112 to avoid high concentrations of optical waveguides 119 at a laser transceiver node 112. Those skilled in the art will appreciate that the optical tap 130 can also be incorporated within the laser transceiver node 112.

Each subscriber optical interface 140, which is coupled to an optical tap 130 via a drop optical waveguide 150, handles downstream analog optical signals 117, downstream digital optical signals, and upstream digital optical signals as well as their electrical counterparts. The upstream and downstream digital optical signals propagate alongside the downstream analog optical signals 117 in the drop optical waveguide 150. The subscriber optical interface 140 includes two receivers 125, 133 that convert the downstream optical signals into the electrical domain for subsequent processing with appropriate communication devices. A transmitter 137 within the subscriber optical interface 140 converts upstream electrical signals from the subscriber's premises into upstream optical signals.

The digital optical signals and the analog optical signals 117 each propagate at a different wavelength. Typically, the analog optical signals 117 have a wavelength of approximately 1550 nanometers, while the digital optical signals have a wavelength in the 1310 nanometer region of the optical spectrum. The subscriber optical interface 140 includes an optical diplexer 115 that employs an optical filter (not shown) to separate the digital optical signals and the analog optical signals 117 from one another according to their wavelengths. The diplexer 115 routes analog optical signals 117, which travel in the downstream direction and are emitted by the drop optical waveguide 150, to an analog optical receiver 125. It also routes downstream digital optical signals, which are also emitted by this waveguide 150, to a bidirectional optical signal splitter 120. Finally, it routes upstream digital optical signals from the bidirectional optical splitter 120 into the drop optical waveguide 150.

As described above, digital optical signals in the 1310 nanometer region of the optical spectrum propagate bidirectionally in the drop optical waveguide 150 while analog optical signals 117 propagate uni-directionally in the same optical waveguide in the 1550 nanometer region. The present invention supports optical signals at various wavelengths. While the wavelength regions discussed are practical, they are only illustrative of exemplary embodiments. Those skilled in the art will appreciate that other wavelengths that are either lower than 1310 nanometers, higher than 1550 nanometers, or between 1310 and 1550 nanometers are not beyond the scope of the present invention.

The bidirectional optical signal splitter 120 handles both upstream and downstream digital optical signals, each having essentially the same wavelength but distinct information content. A digital optical transmitter 137 generates the upstream digital optical signals, while a digital optical receiver 133 receives the downstream optical signals.

One or more photoreceptors, photodetectors, or photodiodes in the digital optical receiver 133 receive the downstream digital optical signals, which were initially generated in the data service hub 102 and arrived at this receiver 133 via the optical diplexer 115 and the bidirectional optical signal splitter 120. The photodiode converts the downstream digital optical signals into electrical binary/digital signals. Signal conditioning components process these signals in the electrical domain in preparation for transmitting them to the processor 153 and onto the subscriber 142.

One or more lasers, such as a Fabry-Perot (“F-P”) laser, a distributed feedback (“DFB”) laser, or a vertical cavity surface emitting laser (“VCSEL”), in the digital optical transmitter 137 generates digital optical signals based on digital upstream electrical signals from the processor 153. That is, a laser converts binary/digital electrical signals into the optical domain for transmission onto the optical waveguide 150 via the bidirectional optical splitter 120 and the optical diplexer 115. In this manner, information generated at the subscriber premises travels upstream to the data service hub 102 in a digital format.

The processor 153 that is electrically coupled to the digital optical receiver 133 and the digital optical transmitter 137 selects data intended for the instant subscriber optical interface 140 based upon an embedded address. This processor 153 handles one or more of telephony and data services, such as an Internet service, and communicates with a telephone input/output 155 and a data interface 160 to provide these services. The data interface 160 provides a communication link to computer devices, set top boxes, integrated services digital network (“ISDN”) phones, and other like devices on the premises of the subscriber 142. In one embodiment, the data interface 160 interfaces with a voice over Internet protocol (“VoIP”) telephone and/or an Ethernet telephone. The data interface 160 can also be tailored for one or more specific communication standards, such as Ethernet (10BaseT, 100BaseT, Gigabit), HPNA, universal serial bus (“USB”), IEEE 1394, and asymmetric data subscriber line (“ADSL”).

In addition to these digital services, the subscriber optical interface 140 provides analog services, such as downstream broadcast video, to the subscribers 142. As described above, the optical diplexer 115 diverts the analog optical signals 117, which carry these services, to the analog optical receiver 125.

The analog optical receiver 125 converts the downstream broadcast optical video signals 117 into modulated radio frequency (“RF”) television signals 195 that propagate through the modulated RF unidirectional signal output 135. The modulated RF unidirectional signal output 135 feeds one or more RF receivers such as television sets or radios. In one embodiment of the present invention, the analog optical receiver 125 processes analog modulated RF transmission as well as digitally modulated RF transmissions for digital TV applications. Those skilled in the art further appreciate that digital content can be encoded in the analog optical signals 117 and analog electrical signals that propagate in the illustrated optical network 100.

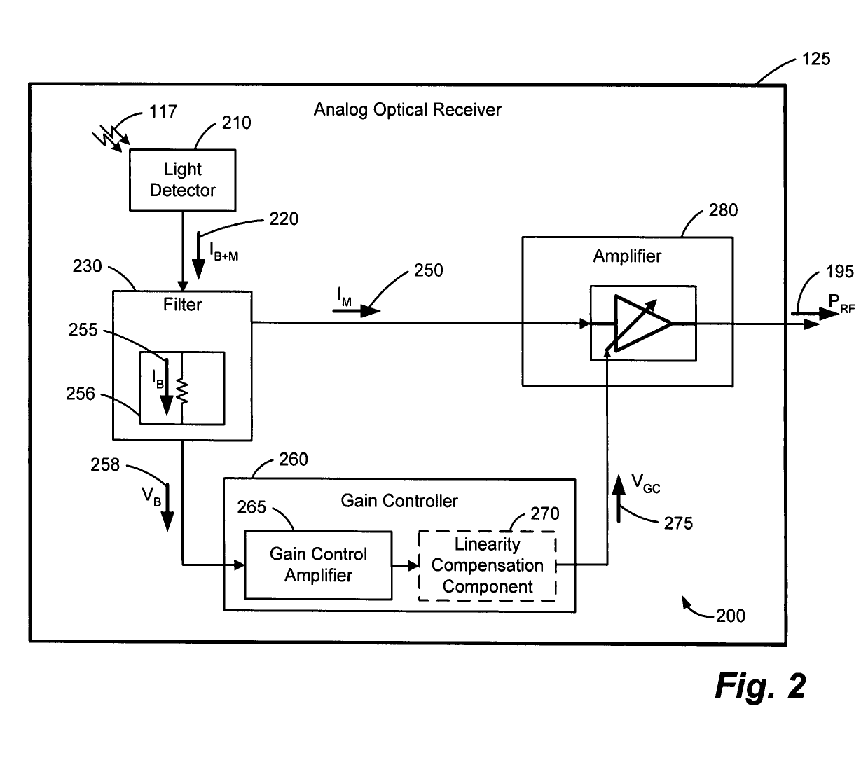

Turning now to FIG. 2, this Figure presents a functional block diagram of a receiver circuit 200 in an analog optical receiver 125 according to an exemplary embodiment of the present invention. While the receiver circuit 200 will be described below with respect to the optical network 100 illustrated in FIGS. 1A and 1B, those skilled in the art appreciate that the receiver circuit 200 of the present invention is suited to a wide variety of optical communication applications.

Those skilled in the art recognize that the functions performed by each of the functional blocks illustrated in FIG. 2 and referenced in subsequent figures can be distributed functions. That is, some embodiments of the present invention do not provide a clean demarcation between each of the functional blocks. A single circuit element, such as a resistor, operational amplifier, capacitor, or inductor, can perform a function that is illustrated in two or more functions blocks. For example, one resistor can be an element both in the filter 230 and in the gain controller 270.

The circuit 200 presented in FIG. 2 includes a light detector 210, such as an optical detector 210, that receives an optical signal 117 emitted by an optical waveguide 150. In one embodiment of the present invention, the optical signal 117 passes through a diplexer 115 before coupling into the light detector 210.

The optical signal 117 includes a bias optical signal and a modulated optical signal. The bias optical signal is a base level of light, which can be the average light intensity over multiple modulation cycles. The modulated optical signal rides on the bias optical signal and carries information. The amplitude of the modulated optical signal oscillates up and down, between a peak minimum and a peak maximum. The bias optical signal ensures that when the modulated optical signal at the peak minimum in an oscillation cycle, intensity remains in the optical signal 117. That is, a modulation drives the laser (not shown) in the outdoor laser transceiver node 112 to output an intensity of light that oscillates; however, the modulation does not cause this laser to stop outputting light or to drop below its lasing threshold.

The bias optical signal may fluctuate or drift over time due to environmental variations in the communication network 100 or other influences. Significant fluctuation in the base level of light typically occurs on a time scale that is greater than one second, and more commonly is measured in minutes, hours, or days. Such fluctuation is not ordinarily an intentional fluctuation that carries information content.

While the bias optical signal should be relatively stable, the modulated component of the optical signal 117 changes in a specified pattern that defines communicated information. This modulation typically occurs on a much faster timescale than the aforementioned fluctuations of the bias optical signal. The modulation typically includes oscillations with kilohertz or higher frequencies. In one embodiment of the present invention, the modulated optical signal includes megahertz oscillations. In one embodiment of the present invention, the modulated signal includes gigahertz oscillations. In other words, the modulation can have a frequency spectrum that spans into the gigahertz range.

The light detector 210 can be an optoelectronic detector such as a photodiode composed of indium gallium arsenide, indium phosphide, or other semiconductor optoelectronic material. In conjunction with a voltage source (not illustrated in FIG. 2) the light detector 210 generates a current signal 220 corresponding to the optical signal 117 that it receives. The current 220 has at least two components, a bias current 255 and a modulated current 250. The bias current 255 corresponds to the bias optical signal, while the modulated current 250 corresponds to the optical signal modulation.

The receiver circuit 200 also includes a filter 230 that separates the bias current 255 from the modulated current 250. That is, the receiver circuit 200 includes a filter circuit 230 that performs a filtering function and diverts a direct current 255 portion of the current signal 220 along a separate path from the modulated current signal 250. The modulated current 250 propagates to an amplifier 280 with adjustable gain that amplifies it to increase its signal strength to a robust and consistent level that facilitates processing by downstream hardware. Rather than a single, discrete component, the amplifier 280 is typically an amplifier circuit 280. The bias current 255 propagates through a voltage converter 256, such as a resistor, that produces a bias voltage 258 in proportion to the magnitude of the bias current 255. The bias voltage 258 transmits to a gain controller 260 that is typically a gain control circuit 260.

The gain controller 260 processes the bias voltage 258 to generate a gain control voltage 275, which the amplifier 280 receives for gain control. That is, the gain controller 260 adjusts the amplifier's gain according to the bias voltage 258. The gain controller 260 includes a gain control amplifier 265 that amplifies the bias voltage 258 and places it in a range suitable for controlling the amplifier 280. This feedforward control maintains the RF modulated output 195 at a consistent signal strength without the need for monitoring the signal strength of that output 195 directly. In other words, the control architecture illustrated in FIG. 2 illustrates an exemplary embodiment of the present invention that incorporates feedforward control rather than closed loop feedback control.

The term “feedforward control,” as used herein, refers to modifying the performance of a device, such as a section of a receiver circuit that has multiple circuit components, based on an input to that device. The term “feedback control,” as used herein, refers to modifying the performance of a device based on an output of that device.

One principle upon which the control architecture operates is the correlation between the attenuation of the bias optical signal and the modulated optical signal in the optical network 100. As the bias optical signal and the modulated optical signal propagate in the optical network 100, environmental and network factors attenuate each similarly. In other words, an optical effect that causes attenuation in the modulated optical signal generally causes a corresponding attenuation in the bias optical signal and vice versa.

Using this principle, the receiver circuit can apply gain to the modulated current 250, which corresponds to the modulated optical signal, based on the bias current 255, which corresponds to the bias optical signal. Those skilled in the art appreciate that the correlation need not be exact and the principle of operation need not be perfect for the receiver circuit 200 to function as intended.

Some exemplary embodiments of the present invention that are described herein include a linearity compensation component 270 within the control circuit, while others do not. In other words, the linearity compensation component 270 is an optional component in certain embodiments of the present invention. In addition to the exemplary receiver circuits illustrated in FIGS. 2-8, the linearity compensation component 270 is applicable to optical receiver circuits based on open loop feedforward control. That is, the gain controller 260 of a feedforward gain control system can include a linearity compensation component 270 that improves the performance of the amplifier 280 and the system.

As is understood by those skilled in the art, a light detector 210 usually acts as a high impedance, or a current source. The power of a signal is proportional to the square of the current, as is understood by those skilled in the art, so a current may represent a signal power or intensity. In the amplifier 280 the modulated signal current IM 250 is conventionally expressed as a power, and the output of the amplifier is also conventionally expressed as power, PRF 195.

The linearity compensation component 270 adjusts the gain control voltage 275 to compensate for nonlinearity in the amplification gain as a function of the gain control voltage 275 of the amplifier 280 and/or in the other components of the control system. The amplifier 280 amplifies the modulated current 250 according to the gain control voltage 275. If, for example, the gain control voltage 275 is a two-volt signal, the amplifier 280 might scale the modulated current 250 by a factor of two. If the example amplifier 280 was perfectly linear with respect to gain verses control voltage, which is a theoretical device, it would respond to a three-volt input by applying a gain of three to the modulated current 250. Likewise, five-, seven-, and ten-volt control signals would yield corresponding five-, seven-, and ten-fold amplifications in a perfectly linear amplifier. Additionally, a perfectly linear amplifier would amplify the modulated current 250 by the select gain regardless of the level of that modulated current 250. In other words, if the amplifier control signal 275 calls for a gain of three, the amplifier 280 would scale the modulated current 250 three-fold, whether the modulated current 250 was a three-milliampere current or a twenty-milliampere current. Furthermore, a perfectly linear amplifier would apply a consistent amplification to an input signal regardless of extraneous influences such as elevated temperature or other environmental effects.

In one embodiment of the present invention, the linearity compensation component 270 adjusts the gain control voltage, V_{cg}, 275 to negate nonlinearity in the gain verses voltage characteristic of the amplifier 280. For example, suppose an amplifier 280 exhibits amplification that droops at a gain of five. That amplifier 280 might provide amplification gains of 2.00, 3.00, 4.00, and 4.95 in response gain control signals of 200, 300, 400, and 500 millivolts respectively. When the gain controller 260 elects to set the amplifier's gain to 5.00, the linearity compensation component 270 can correct the droop by boosting a 500-millivolt gain control signal to 505 millivolts, thus achieving a gain of approximately 5.00. That is, in this example, the linearity compensation component 270 can improve the linearity of this example amplifier by adding a corrective voltage to the output of the gain control amplifier 265 when such output would generate a nonlinear response from the amplifier 280.

Those skilled in the art appreciate that the preceding explanation of linearity is simplified for explanatory purposes. Those skilled in the art further realize that certain amplifier control schemes provide amplification that is linear on a logarithm scale. That is, a specified change in an amplifier control voltage 275, as measured in volts, causes a corresponding and uniform change in amplifier output 195, as measured in decibels.

The amplifier 280 of the present invention, like any physical amplifier and most other devices, is not perfectly linear. A typical amplifier has a range over which it provides acceptably linear gain response to changes in gain control voltage 275. In one embodiment of the present invention, the linearity compensation component 270 extends the range over which an amplifier 280 provides acceptable amplification, such as linear or otherwise predictable amplification.

In one embodiment of the present invention, the linearity compensation component 270 allows the amplifier 280 to linearly amplify modulated currents 250 that have a wider current range than is otherwise feasible. It also helps the amplifier 280 respond more predictably and/or uniformly to a wide range of amplifier control signals 275. That is, the linearity compensation component facilitates precise control of the amplifier 280 and its amplification characteristics.

In one embodiment of the present invention, the linearity compensation component 270 improves the linearity of the amplifier 280 over a specified range. That is, for modulated input currents 250 within a given current range, it provides a more uniform and predictable amplification than is otherwise feasible. This characteristic yields output amplified signals 195 that exhibit improved signal characteristics.

Furthermore, in one embodiment of the present invention, the linearity compensation component 270 helps the amplifier 280 provide more robust amplification that is less susceptible to environmental influences, such as temperature. For such temperature compensation, the analog optical receiver 125 can include a temperature sensor (not shown in FIG. 2), such as a thermistor mounted adjacent the amplifier 280 that sends temperature information to the gain controller 260.

In one embodiment of the present invention, temperature compensation enables the analog optical receiver 125 to provide acceptable performance without thermoelectric cooling, forced air, or other active cooling when the temperature inside an enclosure that houses the receiver circuit 200 is between −40 degrees Celsius and 85 degrees Celsius. In one embodiment of the present invention, temperature compensation enables the analog optical receiver 125 to provide acceptable performance without active cooling when the temperature of the environment is between −40 degrees Celsius and 60 degrees Celsius.

Finally, the linearity compensation component allows an analog optical receiver circuit 200 to be configured in an architecture that provides performance, reliability, and cost benefits. For example, the linearity compensation component 270 facilitates high-performance functionality with a feedforward control implementation, such as the scheme illustrated in FIG. 2. With such heightened performance, a low-cost amplifier, such as a single-stage amplifier, can be used in an optical receiver 125 rather than a more expensive alternative.

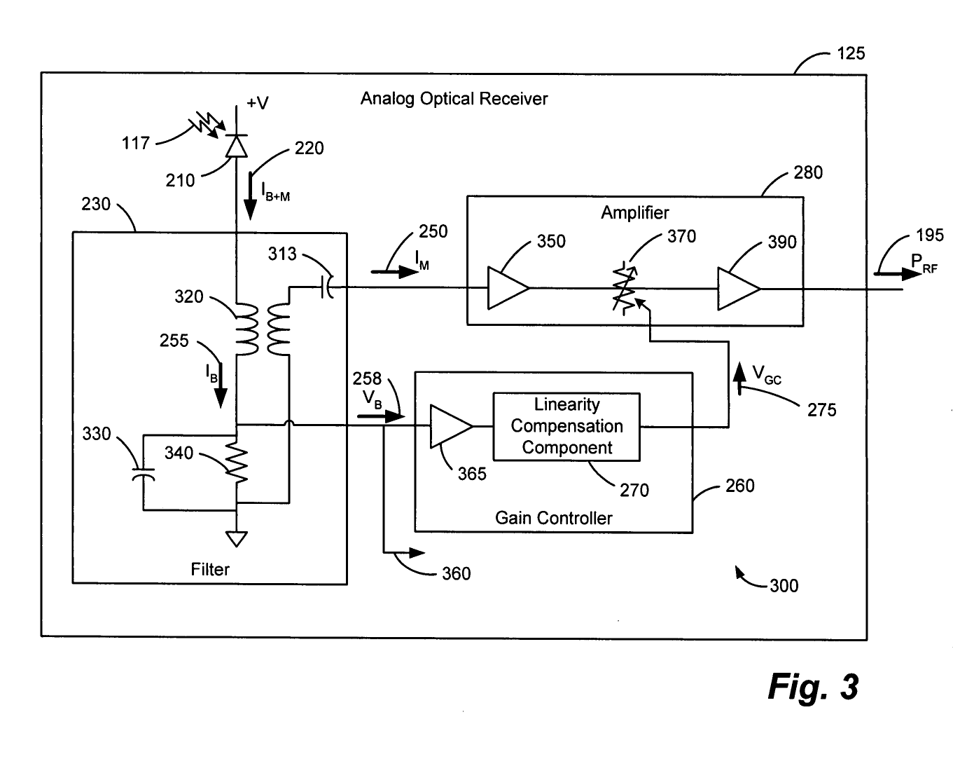

Turning now to FIG. 3, this Figure illustrates a schematic representation of an optical receiver circuit 300 with an impedance matching transformer 320 and feedforward gain control according to one exemplary embodiment of the present invention. The circuit 300 includes an exemplary filter 230, an exemplary gain controller 260, and an exemplary amplifier 280, each of which can be a circuit within the broader analog optical receiver circuit 300.

The photodiode 210 receives an optical signal 117 which includes a modulated optical signal and a bias optical signal. In conjunction with a voltage supply, this light detector 210 coverts the optical signal 117 into a current 220 which passes through the primary coil of an impedance matching transformer 320 and finally to ground. The current 220 includes a modulated current component 250 and a bias current 255, corresponding to the modulated optical signal and the bias optical signal respectively. The secondary of the impedance matching transformer 320 is connected to a direct current (“DC”) blocking capacitor 313. This blocking capacitor 313 passes the transformed modulated current 250 while permitting the amplifier's first stage 350 to be biased as needed. A typical value for this DC blocking capacitor 313 is 0.01 microfarads.

The amplifier's first stage 350, which is coupled to the secondary of the transformer 320, typically prefers to operate at a lower impedance than the optical receiver photodiode 210, which is coupled to the transformer's primary. The impedance matching transformer 320 is typically a step-down transformer 320, such as a two-to-one transformer or a three-to-one transformer. While the impedance matching transformer 320 serves to address impedance mismatch, it does not provide a perfect impedance match over the full frequency spectrum of the modulated current 250. The impedance of the photodiode 210 can be described as essentially infinite in that it delivers a certain level of current with minimal dependence on the load applied to that current. In contrast, the input impedance of the amplifier 350 can be described as finite, typically but not necessarily between about 50 and 75 ohms. Consequently, the transformer 320 does not exactly match the impedance of the photodiode 210 to the impedance of the amplifier 280. Rather, the transformer 320 effectively amplifies the transformed current I_{M} 250 that flows from the secondary to the amplifier stage 350.

The modulated current 250 in the secondary of the step down transformer 320 is higher than the modulated current in the primary, which means that more power can be delivered to the amplifier stage 350. Those skilled in the art appreciate that, although this statement implies perfect impedance matching, the statement holds for practical purposes since the impedance from the photodiode 210 can be described as infinite as discussed above. Thus, the step-down transformer 320 can increase the amount of signal current 250 delivered to the amplifier stage 350. The term “step-down” applies to the behavior of the transformer 320 with regard to impedance. The secondary has fewer turns than the primary, and hence operates at a lower impedance level and couples more current I_{M} 250 to the input of amplifier 350.

The modulated current I_{M} 250 coupled to the amplifier 280 is the secondary current developed as a result of the signal component of the primary current I_{B+M} 220. The current 220 output from the photodiode 210 flows through the primary of the transformer 320. At the low end of the transformer's primary, the bias current 255, which is essentially a direct current, passes through the current sense resistor 340 and develops a voltage drop 258 across that resistor 340. On the other hand, the signal component flowing through the primary passes substantially through the bypass capacitor 330 and to ground. The transformer 320 induces a secondary current I_{M} 250 as a direct result of the signal component of the primary current. In other words, current I_{M} 250 is a direct result of, and is proportional to, the signal component of I_{B+M} 220. Furthermore, I_{M} 250 flowing to the amplifier 280 is larger in magnitude than the signal component of I_{B+M} 220 flowing from the photodiode 210 through the primary.

The RF bypass capacitor 330 shunts any of the modulated current 255 that was not directed to the amplifier 280 to ground and blocks the bias current 250, forcing it to flow through the current sense resistor 340. That is, the RF bypass capacitor 330 diverts residual modulated current away from the current sense resistor 340. A typical value for this RF bypass capacitor 330 is 0.01 microfarads.

The current sense resistor 340 creates a voltage drop proportional to the bias current 255. Since the bias current 255 corresponds to the bias optical signal, the voltage 258 across the current sense resistor 340 essentially measures that bias optical signal. A typical value for this current sense resistor 340 is 500 ohms.

A circuit tap 360 outputs this bias voltage 258 so that devices external to the analog optical receiver 125 can access a measurement of the average optical power level of the light 117 impinging on photodiode 117. In one embodiment of the present invention, the circuit tap 360 feeds a signal conditioning circuit (not shown).

The gain controller 260 receives this bias voltage 258 and uses it to generate a gain control signal 275. Although the gain control signal 275 is typically a gain control voltage 275, it can be an alternative signal form, such as a gain control current. The gain controller 260 includes a feedforward gain control amplifier 365 that amplifies the bias voltage 258 to place it in the proper voltage range to control the amplifier 280 of the modulated current 250. The feedforward gain control amplifier 365 can be an operational amplifier or other components known in the art and can scale the bias voltage 258 by approximately a factor of twenty according to one exemplary embodiment of the present invention. Typical amplifier suppliers include Texas Instruments, Analog Devices, Motorola Semiconductor and many, many other suppliers known to those skilled in the art. The linearity compensation component 270 adjusts the output of the feedforward gain control amplifier 365 to correct nonlinearity in the system 300, thus generating a gain control voltage 275.

The amplifier 280 includes a variable attenuator 370 that receives and responds to the gain control voltage 275. That is, the gain control voltage 275 adjusts the variable attenuator 370 in order to control the overall gain of the amplifier 280. The variable attenuator 370 can be implemented with positive-intrinsic-negative (“PIN”) diodes or other circuitry known in the art.

The amplifier 280 includes a first stage amplifier 350 and a second stage amplifier 390. The first stage amplifier 350 applies an initial level of amplification, such as approximately twenty decibels. The variable attenuator 370 attenuates the output of the first stage amplifier 350 according to gain control voltage 275 generated by the gain controller 260. The second stage amplifier 390 applies a final level of amplification and outputs the amplified RF output 195. A typical gain for the second stage amplifier 350 is 16 decibels. The variable attenuator typically applies an attenuation that can be adjusted between approximately 2 and 17 decibels. The first and second stage amplifiers 350, 390 can be implemented with gallium arsenide amplifiers or other circuitry known in the art. Typical suppliers include RF Monolithics, Inc. and other companies known to those skilled in the art.

If an amplifier coupled to a photodiode, such as the amplifier 280 and photodiode 210 arrangement of Circuit 300, were operated without gain control, each decibel of change in the level of the optical input 117 would generate approximately two decibels of change in the level of the RF output signal 195. In contrast, Circuit 300 can provide essentially no measurable change in the level of the RF output signal 195 in response to a one-decibel change in the level of the light 117. Such control over the level of the RF output 195 avoids overly strong RF signals 195 that can cause unwanted effects, such as distortion in a video display. Furthermore, the control provided by Circuit 300 avoids weak RF signals 195 that can cause noise, or snow, in a video display, among other problems. The total gain of the amplifier 280 is typically adjustable between 12 and 27 decibels.

When the intensity of the optical signal 117 that is incident on the photodiode 117 diminishes, the bias current 255 flowing through the current sense resistor 340 drops, as does the bias voltage 258, which is the voltage drop across that resistor 340. In response, the gain controller 260 decreases the attenuation of the variable attenuator 370, thereby increasing the net amplification gain of the amplifier 280. Similarly, when the intensity of the optical signal 117 increases, the control scheme reduces the gain of the amplifier 280. This action maintains the RF output 195 at a consistent level despite fluctuation or drift in the intensity of the light 117 impinging on the photodiode 210. The circuit 300 provides such gain compensation without need for monitoring the RF output 195 directly.

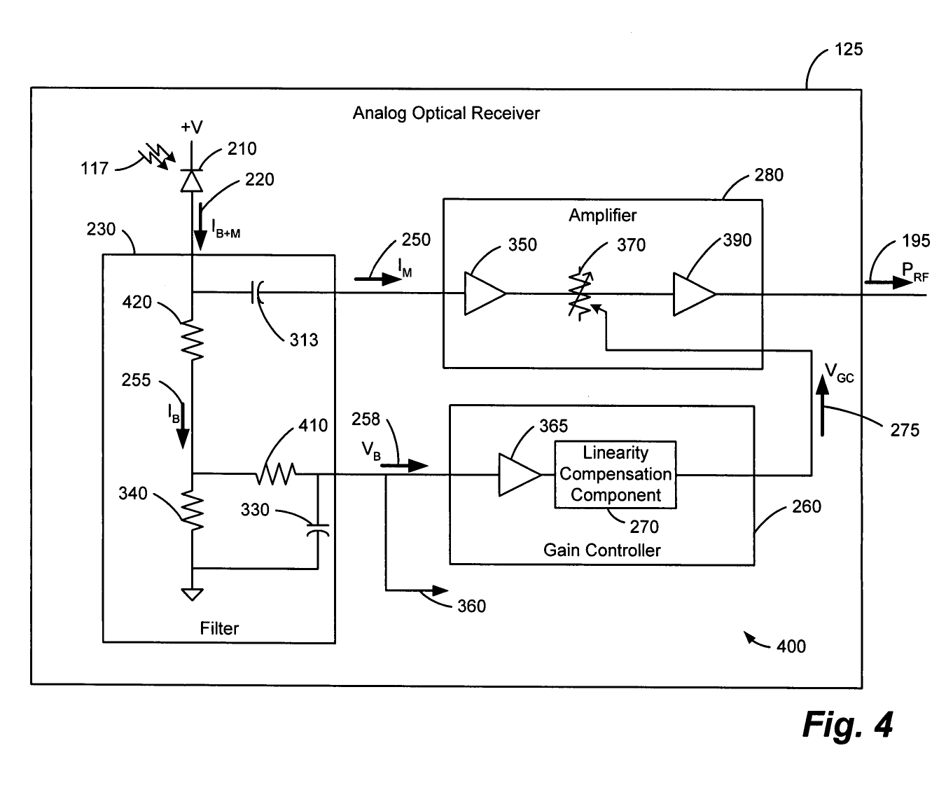

Turning now to FIG. 4, this Figure illustrates a schematic representation of an optical receiver circuit 400 with feedforward gain control of a two-stage amplifier 280 according to an exemplary embodiment of the present invention. The circuit 400 includes an exemplary filter 230, an exemplary gain controller 260, and an exemplary amplifier 280, each of which can be a circuit within the broader receiver circuit 400.

This exemplary circuit 400 does not include a step-down transformer in the coupling between the photodiode 210 and the amplifier 280. Although the lack of a transformer causes some signal loss in the modulated current I_{M} 250, transformers cause their own signal loss as well as additional complications such as frequency roll-off. These deficiencies are related to the operation of real transformers, which have stray capacitive coupling between turns and between windings, as is understood by those skilled in the art. The deficiencies can override the advantage of increased current that is possible with a step-down transformer.

The photodiode 210 generates a modulated current 250 and a bias current 255 corresponding to the modulated optical signal and the bias optical signal respectively, which are components of the optical signal 117. The filtering circuitry 230 of the receiver circuit 400 directs the modulated current 250 to a two-stage amplifier 280 and outputs a voltage 258 corresponding to the bias current 255. In one embodiment of the present invention, the photodiode 210 is physically removed from the printed wiring board of the two-stage amplifier 280.

In one embodiment of the present invention, the circuit 400 includes an inductor (not shown) in the signal path of the modulated current 250. A small inductance in series with the photodiode 210 can improve the response, especially at high frequencies, by compensating for stray capacitance in the circuit 400 and on the circuit board (not shown). This inductor can be with located on the output side of the photodiode 210 in the path of the combined modulation and bias current 220. Alternatively, the inductor can be in series with the blocking capacitor 313. A typical inductance value for this inductor is 5.6 nanohenries.

The DC blocking capacitor 313 passes modulated current 250 to the amplifier 280 while blocking the bias current 255. On its path to ground, the bias current 255 flows through the series combination of the signal sampling resistor 420 and current sense resistor 340. As the bias current flows through the current sense resistor 340, it generates a bias voltage 360. This bias voltage 360 can be between 5 and 500 millivolts in one exemplary embodiment of the present invention. In order to minimize the flow of modulated current 250 through this path, the resistance of these two resistors 420, 340 should be high and the capacitance to ground should be low. In one exemplary embodiment of the present invention, Resistor 420 is approximately 1500 ohms while Resistor 340 is approximately 500 ohms. The RF decoupling resistor 410 isolates the gain controller 260 from any residual signal current 250 that may flow through the bias resistor 340. In other words, the gain controller 260 picks up the bias voltage 258, which is developed as the bias current 255 itself flows to ground through bias resistor 340. The RF decoupling resistor 410 can have a resistance of approximately 2,000 ohms. To prevent modulated current flow into the gain controller 260, the RF bypass capacitor 330 shunts any residual modulated current 250 that is inadvertently flowing in this section of the circuit 400. Typical values for this RF bypass capacitor 330 are between 0.01 and 1 microfarad.

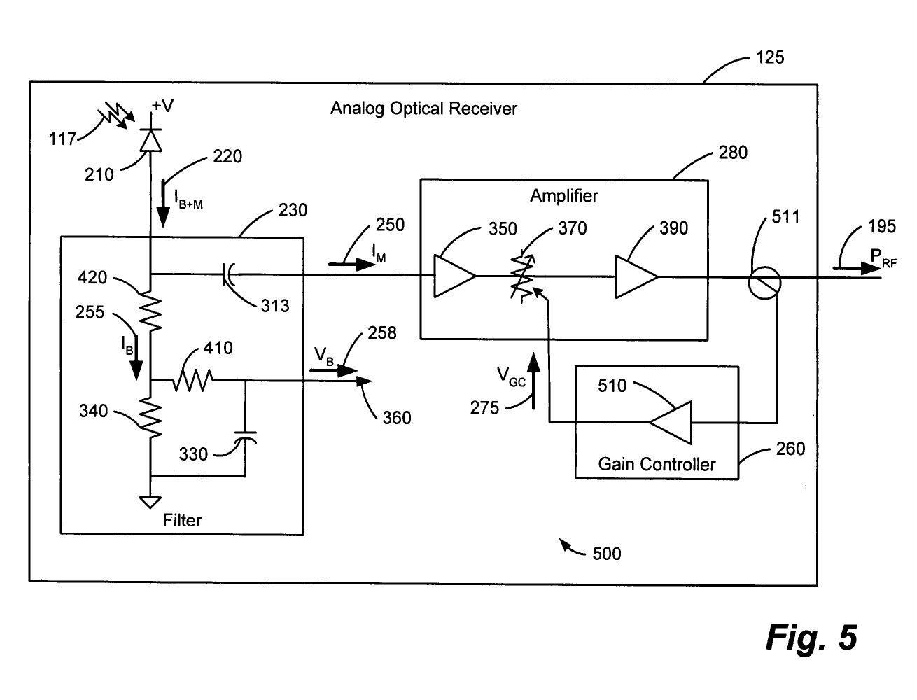

The exemplary amplifier 280 and the exemplary gain controller 260 in Circuit 400 can be essentially the same as the corresponding components included in Circuit 300 of FIG. 3 and described above. That is, Circuit 400 and Circuit 300 differ in terms of the architectures their filtering circuits and the impedances of their photodiode-to-amplifier couplings. Alternatively, the filters 230, amplifiers 280, and gain controllers 260 in these circuits can be distinct. Those skilled in the art appreciate that, if Circuit 400 and Circuit 300 use the same amplifier 280 and gain controller 260, then each of these elements is typically customized or adjusted according to the specific circuit layout and the application. Furthermore, those skilled in the art recognize that such tweaking may be applied to any of the circuits described herein or any of the like-numbered elements in such circuits.

Whereas FIG. 4 illustrates an exemplary embodiment of the present invention with an impedance mismatch in an exemplary feedforward control scheme, FIG. 5 illustrates an exemplary embodiment of the present invention with an impedance mismatch in an exemplary feedback control scheme.

Turning now to FIG. 5, this Figure presents a schematic representation of an optical receiver circuit 500 with feedback gain control of a two-stage amplifier 280 according to an exemplary embodiment of the present invention. The exemplary amplifier 280 and the exemplary filter 230 illustrated in FIG. 5 can be the same as the amplifier 280 and the filter 230 illustrated in FIG. 4 and described above. Alternatively, the filters 230, amplifiers 280, and gain controllers 260 in these circuits can be distinct. The filter 230, the amplifier 280, and the gain controller 260 can each be a circuit within the broader analog optical receiver circuit 500. The receiver circuit 500 of FIG. 5 incorporates these components into a closed loop feedback control scheme using a sample of the RF output 195 as the feedback signal to the gain controller 260. The coupling between the amplifier 280 and the photodiode 117 includes an impedance mismatch.

In one embodiment of the present invention, the circuit 500 includes an inductor (not shown) in the signal path of the modulated current 250. This inductor can be in series with the blocking capacitor 313. Alternatively, the inductor can be with located on the output side of the photodiode 210 in the path of the combined modulation and bias current 220. A typical value for this inductor is 5.6 nanohenries.

The filter 230 outputs the bias voltage 258 through tap 360. This tap 360 offers a real-time measurement of the average optical power level in the optical signal 117 that is incident upon the photodiode 210. Various components in an optical network 100 can access this measurement to determine the operational status of the optical network 500 or other useful information.

A directional coupler 511 diverts a small portion of the RF output signal 195 to the gain controller 260. In one exemplary embodiment of the present invention the direction coupler 511 samples approximately three percent of the RF output 195. The gain controller 260 uses this sampled signal to monitor the intensity of the RF output signal 195. The gain controller 260 in this circuit 500 includes an RF detector (not shown but understood by those skilled in the art) and a feedback gain control amplifier 510 that compares the sampled signal to a reference voltage (not shown). Using the feedback gain control amplifier 510, the gain controller 260 adjusts the gain of the two-stage amplifier 280 according to the difference between the reference voltage and the sampled signal. In one embodiment of the present invention, the reference voltage is set by adjusting a potentiometer (not shown) during setup of the analog optical receiver 125 prior to deploying it in the field. In another embodiment of the present invention, the reference voltage is adjustable during normal field operations. In yet another embodiment of the present invention, the reference voltage is set as part of the procedure for installing the subscriber optical interface 140 at a residence or other establishment.

This reference voltage defines the target signal strength of the RF output signal 195. The gain controller 260 adjusts the amplification of the two-stage amplifier 280 to minimize the difference between the output RF signal 195 and the reference voltage. If the output RF signal 195 is higher than the reference voltage, the gain controller 260 reduces the amplification gain. If the output RF signal 195 is lower than the reference voltage, the gain controller 260 increases the amplification gain. In this manner, the gain controller 260 maintains the RF output signal 195 at a consistent or uniform level that avoids drift.

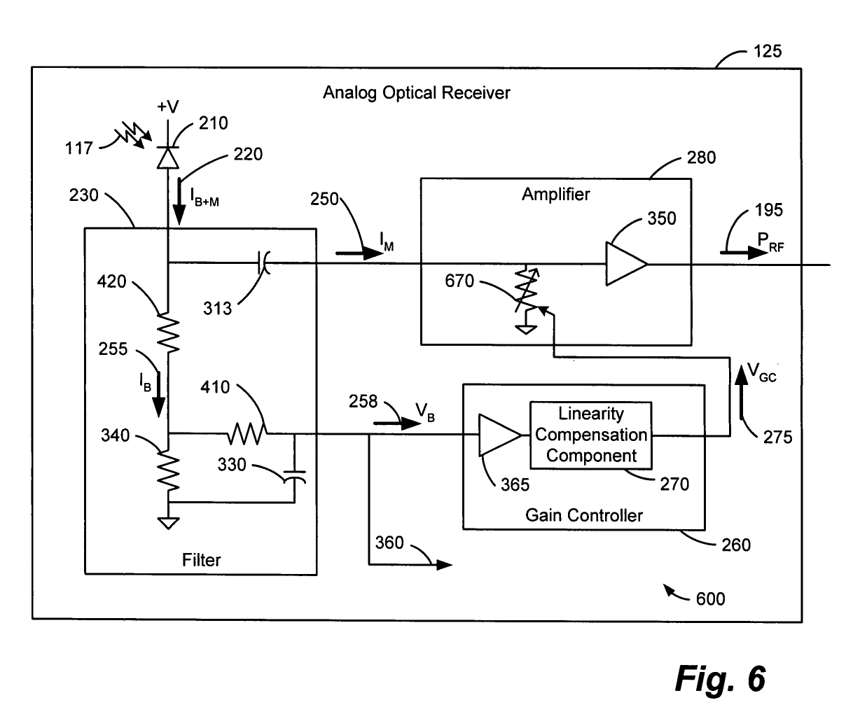

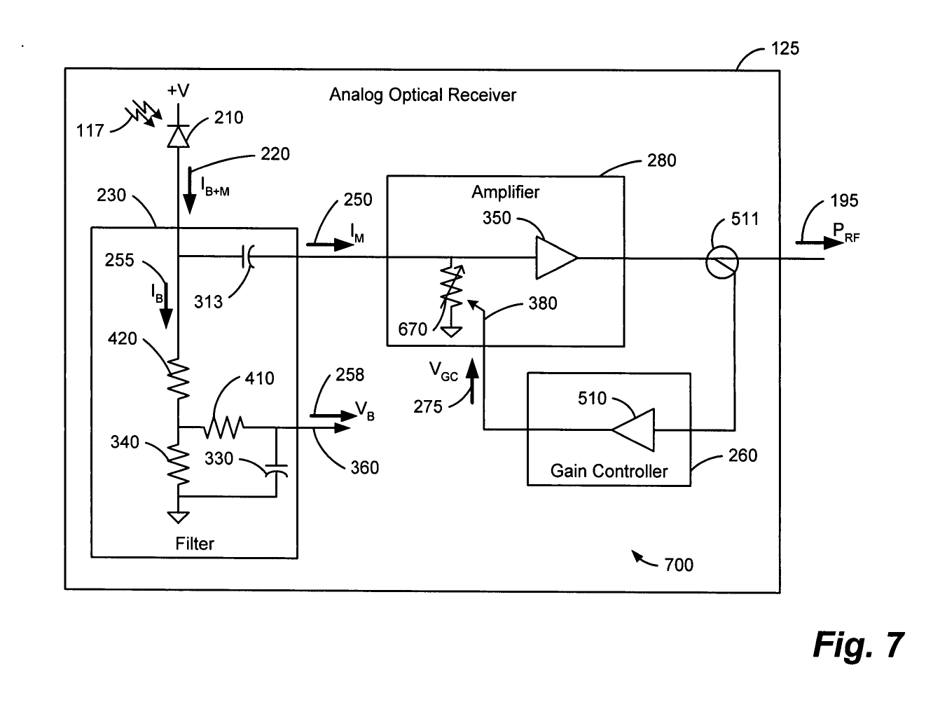

To implement gain control, the gain controller 260 feeds the gain control voltage 275 to a variable attenuator 370 in the amplifier 280. The variable attenuator 370 responds to the gain control voltage 275 and attenuates the modulated signal between the first stage 350 and the second stage 390 of the amplifier 280.

Whereas FIG. 4 and FIG. 5 illustrate exemplary embodiments of the present invention based on a two-stage amplifier 280, FIG. 6 and FIG. 7 illustrate exemplary embodiments of the present invention based on a single-stage amplifier 280.

Turning now to FIG. 6, this Figure illustrates a schematic representation of an optical receiver circuit 600 with linear feedforward gain control of a single-stage amplifier 280 according to an exemplary embodiment of the present invention. The exemplary circuit 600 further includes an impedance mismatch in the coupling between the photodiode 210 and the amplifier 280.

The exemplary filter 230 of FIG. 6 can be essentially the same filter 230 as the filter 230 used in Circuit 400 and Circuit 500, which are illustrated in FIG. 4 and FIG. 5 respectively and described above. Likewise, the exemplary gain controller 260 of FIG. 6 can be essentially the same gain controller 260 as the gain controller 260 of Circuit 300 and Circuit 400, which are illustrated in FIG. 3 and FIG. 4 respectively and described above. Alternatively, the filters 230, amplifiers 280, and gain controllers 260 in each of these circuits can be distinct. The filter 230, the amplifier 280, and the gain controller 260 illustrated in FIG. 6 can each be a circuit within the broader analog optical receiver circuit 600.

In one embodiment of the present invention, the circuit 600 includes an inductor (not shown) in the signal path of the modulated current 250. This inductor can be in series with the blocking capacitor 313. Alternatively, the inductor can be with located on the output side of the photodiode 210 in the path of the combined modulation and bias current 220. A typical value for this inductor is 5.6 nanohenries.

In the exemplary receiver circuit 600 illustrated in FIG. 6, the gain controller 260 supplies the gain control voltage 275 to a variable resistance 670 in the amplifier circuit 280. The variable resistance 670 shunts a variable portion of the modulated current 250 to ground to control the overall gain of the amplifier 280. By adjusting the amplifier's net gain according to the strength of the incoming optical signal 117, the circuit 600 overcomes optical signal drift and maintains a consistent power in the RF output 195.

If, for example, the intensity of the optical signal 117 impinging on the photodiode 210 drops below a steady state level, the bias current 255 also drops. The bias voltage 258 across the current sense resistor 340 responds to the decreased bias current 255 and drops. The gain controller 260 senses the decrease in this voltage 258 and implements the corrective action of adjusting the gain control voltage 275. The gain control voltage 275, in turn, increases the resistance of the variable resistance 670. This increase in variable resistance reduces the portion of the bias current 250 that shunts to ground before flowing to the single-stage amplifier 350 within the amplifier 280. The increase in the current to the amplifier's stage 350 increases the overall gain of the amplifier 280, thereby increasing the strength of the RF output 195. In a similar manner, the circuit 600 responds to an increase in the intensity of the input optical signal 117 by decreasing the resistance in the variable resistance 670.

Several types of commercial devices can be used for the variable resistance 670. One type of commercially available device is a gallium arsenide field effect transformer (“GaAs FET”) which varies its source-to-drain impedance according to the voltage on its gate. Skyworks Solutions, Inc. of Woburn Mass. offers suitable GaAs FET devices within its AF002C1 and AC002C4 product families. Another type of suitable device is a PIN diode that can be used as a single-element variable resistance. Alternatively, multiple PIN diodes can be connected in a pi or T configuration. Skyworks Solutions, Inc. offers suitable devices within its SMP1307 product line.

Turning now to FIG. 7, this Figure illustrates a schematic representation of an optical receiver circuit 700 with feedback gain control of a single-stage amplifier 280 according to an exemplary embodiment of the present invention. The exemplary filter 230 of FIG. 7 can be essentially the same filter 230 used in Circuit 400, Circuit 500, and Circuit 600 and illustrated in FIG. 4, FIG. 5, and FIG. 6 respectively and described above. The exemplary gain controller 260 of FIG. 7 can be essentially the same gain controller 260 used in Circuit 500 and illustrated in FIG. 5 and described above. The exemplary amplifier 280 can be essentially the same amplifier 280 used in Circuit 600 and illustrated in FIG. 6 and described above. Alternatively, the filters 230, amplifiers 280, and gain controllers 260 in each of these circuits can be distinct. The filter 230, the amplifier 280, and the gain controller 260 can each be a circuit within the broader analog optical receiver circuit 700.

In one embodiment of the present invention, the circuit 700 includes an inductor (not shown) in the signal path of the modulated current 250. This inductor can be in series with the blocking capacitor 313. Alternatively, the inductor can be with located on the output side of the photodiode 210 in the path of the combined modulation and bias current 220. A typical value for this inductor is 5.6 nanohenries.

The output of the amplifier 280 includes a directional coupler 511 that feeds a portion of the RF output 195 to the gain controller 260. The gain controller 260 utilizes this signal as a monitor of the signal strength of that RF output 195. A feedback gain control amplifier 510 within the gain controller 260 compares the monitor signal from the directional coupler 511 to a reference signal and adjusts the resistance of the variable resistance 670 accordingly. Adjusting this variable resistance controls the net gain of the amplifier 280 to maintain the RF output 195 at a target signal strength.

If, for example, the monitored portion of the RF output 195 rises above a target setting, the gain controller 260 decreases the resistance of the variable resistance 670, thereby diverting a portion of the modulated current 250 to ground. This action effectively decreases the net amplification gain of the amplifier 280 and reduces the error between the RF output 195 and the target level. Since the control scheme is closed loop, the gain controller 260 continuously adjusts the gain of the amplifier 280 until the intensity of the RF output 195 is equal to the target level. Similarly, the circuit 700 continuously responds to fluctuations in the input optical signal 117 to maintain the RF output 195 at a consistent level.

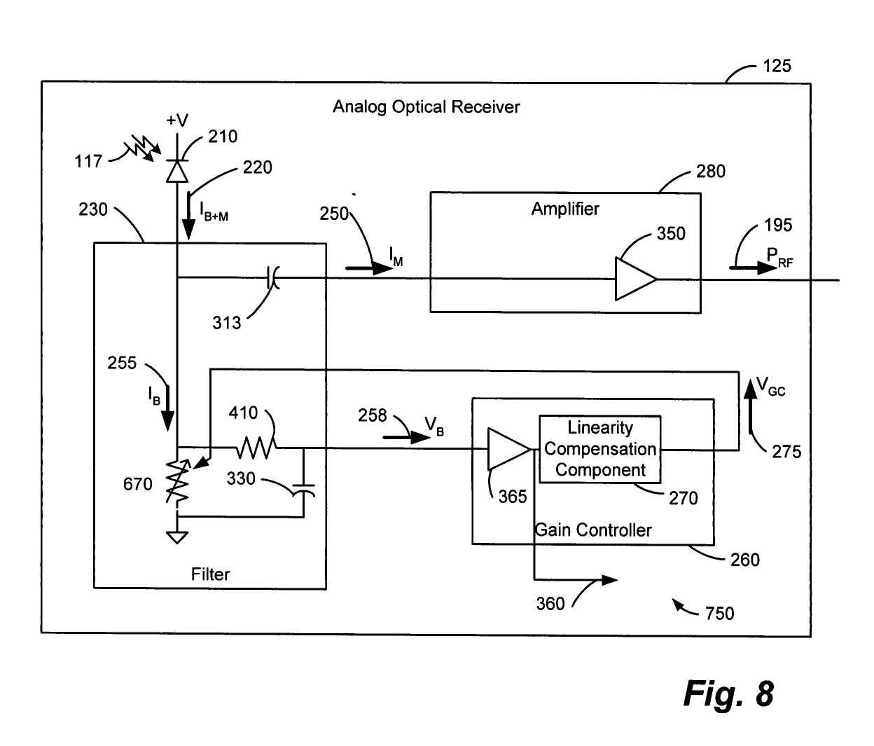

Turning now to FIG. 8, this Figure illustrates a schematic representation of an optical receiver circuit 750 with gain control before amplifier 280. The circuit 750 illustrated in FIG. 8 has some common characteristics with the circuit 600 illustrated in FIG. 6 as well as some distinctions. In both Circuit 600 and Circuit 750, a variable resistive control element 670 at the input of the amplifier 350 controls the level of the RF output signal 195. Electrically, the two circuits 600, 750 are similar in this regard, as the coupling capacitor 313 functions like an electrical short at the frequencies of interest.

One difference between Circuit 600 and Circuit 750 is in the way the bias signal level 255, represented by I_{B}, is used. In Circuit 600, bias current I_{B} 255 is used in a feed-forward correction manner to cause the value of variable resistance 670 to be changed according to the optical signal level 117. In Circuit 750, the feed-forward path is replaced by a true feedback path.

Referring now to Circuit 750 of FIG. 8, variable resistor 670 has its value adjusted by gain control voltage V_{GC} 275 as described above. In one embodiment of the present invention, the linearity compensation component 270 is omitted from Circuit 750. That is, use of a linearity compensation component 270 in this circuit 750 can be optional. The linearity compensation component 270 can provide some beneficial impact on the dynamic operation of the gain control, but the circuit 750 usually provides satisfactory performance for many applications without the linearity compensation component 270.

The feedback (in this example) gain control amplifier 365 of Circuit 750 is connected to the high end of the variable resistance 670 by way of resistor 410 and capacitor 330, which provide a filtering function. Besides filtering out the signal energy, resistor 410 offers a desirably high impedance to the RF signal, so that the RF signal flows predominantly through variable resistance 670. Voltage V_{B} 258 is a function of the intensity of the signal light 117 and the value of the variable resistance 670. The loop adjusts variable resistance 670 to an appropriate value that maintains the voltage V_{B} 258 at an essentially constant level. The signal level represented by I_{M} 250 is also a function of the intensity of light 117, and the available signal level supplied to amplifier 280 is also a function of the value of variable resistance 670. Since the loop is keeping the value of V_{B} 258 constant, it is also keeping the value of the signal into the amplifier 280 constant, thus effecting the desired level consistency in the output 195. Consequently, the control scheme of Circuit 800 provides an RF output signal 195 with a uniform level of signal power 195.

In one embodiment of the present invention, Circuit 750 includes an inductor (not shown) in the signal path of the modulated current 250. This inductor can be in series with the blocking capacitor 313. Alternatively, the inductor can be with located on the output side of the photodiode 210 in the path of the combined modulation and bias current 220. A typical value for this inductor is 5.6 nanohenries.

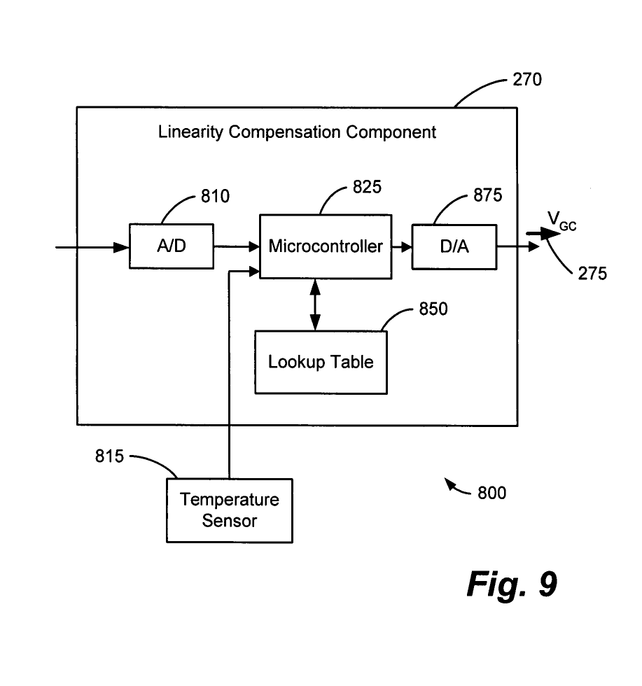

Turning now to FIG. 9, this Figure is a functional block diagram 270 of a linearity compensation component 270 that facilitates linear gain control of an amplifier 280 according to an exemplary embodiment of the present invention. An A/D converter 810 generates a digital representation of a gain control voltage 258 that has not been corrected for nonlinear response. A microcontroller 825 processes this digital signal to provide for needed nonlinear amplification to complement the gain verses voltage characteristics of the attenuator 370. In addition to compensating for nonlinearity of the gain control characteristic of the amplifier 280, the microcontroller 825 compensates for system-wide errors. In one embodiment of the present invention, the microcontroller 825 receives a temperature measurement from a temperature sensor 815, such as a thermistor, mounted on the amplifier 280 or other electrical, optical, optoelectronic, or mechanical component that has a response that varies as a function of temperature. Using this temperature input, the linearity compensation component 270 can compensate for temperature effects in the response of one or more system components.

The microcontroller 825 compares the digitized input to a lookup table 850, which is a data file made up of the amplification response characteristics of the amplification control system. In one embodiment of the present invention, the lookup table 850 specifies the nonlinearity of the response for each uncorrected gain control voltage 258 over a range of gain control voltages 275.

For example, the data in the lookup table 850 might indicate that a 500 millivolt gain control voltage needs a boost of 5 millivolts to generate a linear amplification based on a certain temperature. The microcontroller 825 would read this data and generate a digital signal representation of a 505-millivolt output.

The microcontroller 825 outputs the corrected digital signal to the digital-to-analog “D/A” converter 875. The D/A converter generates an analog voltage, which is a gain control voltage 275, according to the digital output from the microcontroller 825.

In addition to temperature measurements from a temperature sensor, the microcontroller 825 can accept inputs from other sensors and networking components. The microcontroller 825 can adjust the gain control voltage 275 based on one or more of such inputs. That is, the linearity compensation component can adjust the gain control voltage 275 according to any data that indicates the presence of amplification nonlinearity.

In one embodiment of the present invention, the microcontroller 825 is a microprocessor. In another embodiment of the present invention, the microcontroller 825 is hardwired digital logic. In one embodiment of the present invention, a lookup table 850 is not included in a digital implementation of the linearity compensation component 270. In one embodiment of the present invention, a programmable read only memory (“PROM”) stores the lookup table 850 and/or a set of program instructions. The PROM can also be an erasable programmable read only memory (“EPROM”) or an electrically erasable programmable read only memory (“EEPROM”).

In one embodiment of the present invention, the linearity compensation component 270 includes the functions of an amplifier, such as the gain control amplifier 365 illustrated in FIG. 3. While FIG. 9 illustrates an exemplary digital implementation of a linearity compensation component 270, the component 270 can also be analog.

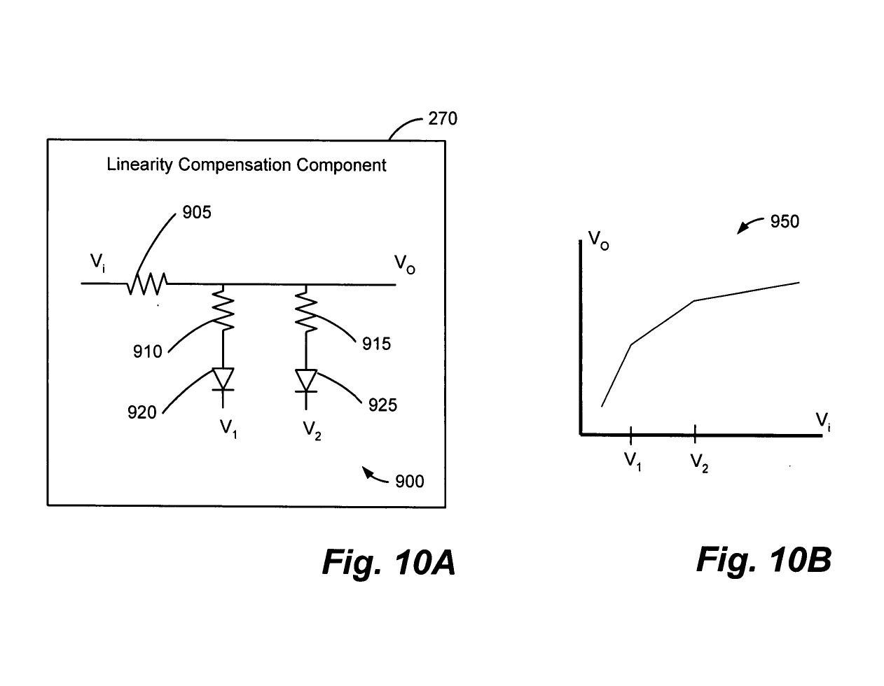

Turning now to FIG. 10A and FIG. 10B, these Figures illustrate an analog implementation of a linearity compensation component 270 according to an exemplary embodiment of the present invention. FIG. 10A illustrates a schematic 900 of an exemplary analog circuit 900 in a linearity compensation component 270. Meanwhile, FIG. 10B illustrates an exemplary response of the circuit 900. When the input voltage, Vᵢ, is lower than the both of the control voltages, V₁ and V₂, both diodes 920, 925 are effectively open, or off. That is, current flows through neither diode 920, 925. In this condition, the output voltage Vₒ is essentially equal to the input voltage Vᵢ. Those skilled in the art appreciate that if the output of the linearity compensation component 270 is coupled to a low impedance device, the output voltage Vₒ will be reduced according to any current that may flow across the line resistor 905.

When the output voltage Vₒ rises above the first control voltage, V₁, the first diode 920 switches on, or effectively becomes a closed circuit. This diode 920 switching on produces a knee in the response 950 of the linearity compensation component 270. Under this condition, current flows through the input resistor 905 and the first control resistor 910. Thus, the two resistors 905, 910 divide the input voltage Vᵢ according to the equation Vₒ=(Vᵢ R₉₁₀+V₁R₉₀₅)/(R₉₁₀+R₉₀₅), where R₉₁₀ is the resistance of Resistor 910 and R₉₀₅ is the resistance of Resistor 905. This equation further defines the slope of the circuit's response 950 between V₁ and V₂.

When the output voltage Vₒ rises above the second control voltage, V₂, the second diode 925 switches on and causes a second knee in the response 950 of the linearity compensation component 270. Under this condition, current flows through both diodes 920, 925. Consequently, the output voltage V_{O}, which is described by the slope of the response 950, is a function of Resistor 905, Resistor 910, and Resistor 915.

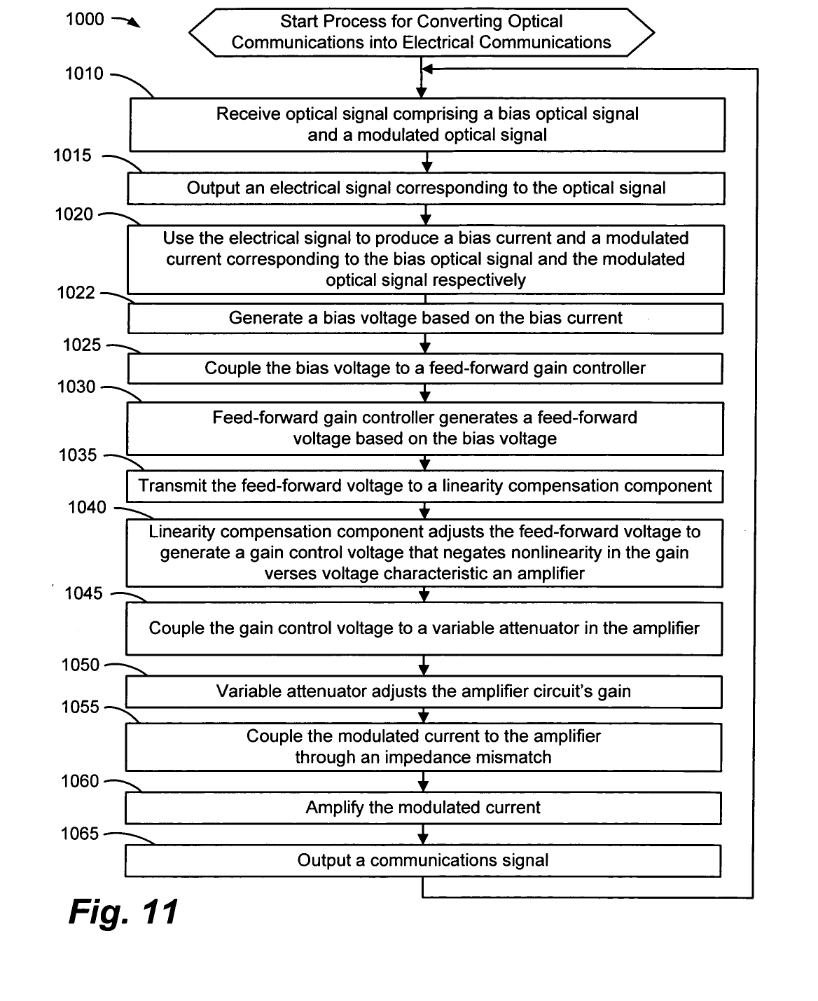

Turning now to FIG. 11, this Figure illustrates a process 1000, entitled Process for Converting Optical Communications into Electrical Communications, for receiving optical signals according to an exemplary embodiment of the present invention. Certain steps in the process 1000 described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

At Step 1010 in Process 1000, a light detector 210, such as a photodiode 210, receives an optical signal 117 comprising a bias optical signal and a modulated optical signal. This optical signal 117 typically passes through an optical port on the light detector 210 and is incident upon an optoelectronic material within the detector 210.

At Step 1015, the light detector 210 outputs an electrical signal corresponding to the optical signal 117. In one embodiment of the present invention, this electrical signal is a current 220. The optoelectronic material in the photodiode 210 responds to the incident light 117 and causes a current 220 that flows from a voltage source external to the photodiode 210.

At Step 1020, one or more circuit components use the electrical signal to produce a bias current 255 and a modulated current 250. The bias current 255 corresponds to the bias optical signal, while the modulated current 250 corresponds to the modulated optical signal. In one embodiment of the present invention, the bias current 255 and the modulated current 250 flow concurrently within a single circuit trace and a filter 230 separates these currents 250, 255 from one another and directs each along a separate circuit pathway. The filter 230 can be a filter circuit 230 made up of multiple discrete and/or integrated components.

At Step 1022, a circuit component 256 converts the bias current 255 into a bias voltage 258. In one embodiment of the present invention, this circuit component is a current sense resistor 340 that generates the bias voltage 258 when the bias current 255 flows through it.

At Step 1025, the bias voltage 258 is coupled to a feedforward gain controller 260 that can be a feedforward gain control 260 circuit. At Step 1030, the feedforward gain controller 260 processes the bias voltage 258 and generates a feedforward voltage. In one embodiment of the present invention, a feedforward gain control amplifier 365 within the feedforward gain control circuit 260 amplifies the feedforward voltage to place it in a suitable voltage range.

At Step 1035, a linearity compensation component 270, typically within the feedforward gain controller 260, receives the feedforward voltage. At Step 1040, the linearity compensation component 270 adjusts the feedforward voltage to negate, or otherwise compensate for, nonlinearity in the gain verses voltage characteristic of an amplifier 280. The adjusted feedforward voltage can be a gain control voltage 275. In one embodiment of the present invention, the adjustment includes applying a correction to the feedforward voltage, wherein the amount of correction depends on the level of the feedforward voltage. In one embodiment of the present invention, the adjustment includes compensating for temperature effects. Step 1040 can also include processing the feedforward voltage with digital logic and/or analog processing.

At Step 1045, the gain control voltage 275 is coupled to a variable attenuator 370, 670 in the amplifier 280. The variable attenuator can be a variable resistance 670, a variable attenuator 370, or other circuit component that reduces the amplification of the amplifier circuit 280. Alternatively, the amplification of the amplifier circuit 280 can be directly adjusted.

At Step 1050, the variable attenuator 370, 670 responds to the gain control voltage 275 and sets the gain of the amplifier circuit 280. At Step 1055, the modulated current 250 is coupled to the amplifier 280 through an impedance mismatch. That is, in one embodiment of the present invention, the modulated current 250 is coupled to the amplifier 280 directly, rather than through an impedance matching component such as a wire-wound transformer. In another embodiment of the present invention, an impedance matching transformer 320 is present in the coupling between amplifier 280 and a light detector 210.

At Step 1060, the amplifier 280 amplifies the modulated current 250 based on the gain established by the gain control voltage 275. Amplifying the modulated current 250 can include converting that current 250 into a modulated voltage and amplifying that voltage. At Step 1065, the amplifier 280 outputs a communication signal 195. The communication signal 195 can be a voltage, current, radio frequency or other signal form.

In one exemplary embodiment of the present invention, this communication signal 195 is an analog signal; however, those skilled in the art appreciate that the present invention supports a variety of output signals. In one embodiment of the present invention, the communication signal 195 carries data, such as digital information. In one embodiment of the present invention, the communication signal 195 carries video, such as broadcast video or digital video.

Process 1000 iterates Steps 1010-1065 to provide ongoing compensation for variations in the intensity of the optical signal 117 received in Step 1010 and in the performance characteristics of the circuit components that carryout Process 1000. Each iterative pass can implement a fraction of the total correction needed to achieve a desired level of compensation. That is, iterating Steps 1010-1065 allows Process 1000 to remove the effect of changes in optical signal level 117. In this manner, the present invention can compensate for dynamic conditions and maintain the strength of the radio frequency output signal 195 at a robust and consistent level.

In summary, the present invention provides a cost effective circuit for receiving analog optical signals that linearly compensates for optical power fluctuation. The present invention also provides feedforward control of an amplifier in an optical receiver circuit. Further, the present invention provides a receiver circuit that performs adequately with impedance mismatch in the coupling between a photodiode and an amplifier and does not require a transformer in this coupling. Consequently, the present invention facilitates extending optical networks to end users.

From the foregoing, it will be appreciated that the present invention overcomes the limitations of the prior art. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims below.

What is claimed is:

1. A method for converting an optical communications signal into the electrical domain comprising:
converting the optical communications signal into an electrical signal comprising a modulated electrical signal and a bias electrical signal;
generating a control signal based on the bias electrical signal;
controlling a gain in a feedforward manner with the control signal; and
amplifying the modulated electrical signal according to the gain.

2. The method of claim 1, wherein the controlling step further comprises applying the control signal in the feedforward manner to control an amplifier.

3. The method of claim 1, wherein generating the control signal comprises generating a signal to compensate for fluctuations in voltage of the electrical signals.

4. The method of claim 1, wherein controlling the gain comprises compensating for a nonlinearity in a gain verses control signal characteristic.

5. The method of claim 1, wherein generating the control signal comprises generating a signal to compensate for fluctuations in voltage of the electrical signals due to temperature.

6. The method of claim 1, wherein the generating step further comprises generating a digital bias electrical signal and processing the digital bias electrical signal.

7. The method of claim 1, wherein the optical signal comprises a bias optical signal and a modulated optical signal and wherein the converting step further comprises:
generating the modulated electrical signal corresponding to the modulated optical signal; and
generating the bias electrical signal corresponding to the bias optical signal.

8. The method of claim 1, wherein controlling the gain of the amplifier comprises adjusting an attenuation of the modulated electrical signal.

9. The method of claim 1, wherein the controlling step further comprises compensating for a fluctuation in the optical signal.

10. The method of claim 1, further comprising the step of propagating the modulated electrical signal through an impedance mismatch.

11. The method of claim 1, wherein the converting step further comprises outputting the electrical signal from a photodiode, and wherein the amplifying step further comprises amplifying the modulated electrical signal with an amplifier, and wherein the method further comprises the steps of:
coupling the optical signal from an optical waveguide to the photodiode; and
transmitting the modulated electrical signal through an impedance mismatch between the photodiode and the amplifier.

12. The method of claim 1, wherein controlling the gain in the feedforward manner comprises modifying a performance of an amplifier based on an input to the amplifier.

13. A method for converting optical communication signals into electrical communication signals comprising:
receiving light from a waveguide;
generating an electrical current corresponding to the received light;
transmitting a modulated component of the electrical current through an impedance mismatch;
applying amplification to the modulated component of the electrical current; and
adjusting the amplification.

14. The method of claim 13, wherein adjusting the amplification comprises adjusting the amplification according to an intensity of the received light.

15. The method of claim 13, wherein adjusting the amplification comprises adjusting the amplification based on the amplified modulated component of the electrical current.

16. The method of claim 13, wherein adjusting the amplification comprises adjusting the amplification based on the electrical current.

17. An optical receiver comprising:
a light detector comprising an optical port and an electrical port;
an amplifier comprising:
an input port coupled to the electrical port of the light detector;
an output port; and
a gain control port; and
a gain control circuit comprising a linear compensator, wherein the gain control circuit is coupled to the electrical port of the light detector and to the gain control port of the amplifier.

18. The optical receiver of claim 17, wherein the gain control circuit further comprises an analog-to-digital converter.

19. The optical receiver of claim 17, wherein the linear compensator comprises digital logic.

20. The optical receiver of claim 17, wherein the linear compensator comprises a lookup table.

21. The optical receiver of claim 17, wherein the gain control circuit comprises a microcontroller.

22. The optical receiver of claim 17, wherein the linear compensator adjusts for a nonlinear gain verses control voltage characteristic of the amplifier.

23. The optical receiver of claim 17, wherein the optical port of the light detector is coupled to an optical waveguide of a fiber-to-the-home optical network.

24. The optical receiver of claim 17, wherein the optical receiver further comprises a temperature sensor coupled to the gain control circuit.

25. The optical receiver of claim 17, wherein the coupling between the electrical port of the light detector and the input port of the amplifier comprises an impedance mismatch.

26. The optical receiver of claim 17, wherein a wire-wound transformer is not coupled between the electrical port of the light detector and the input port of the electrical amplifier.

27. The optical receiver of claim 17, wherein the amplifier is operative to output a radio frequency signal through its output port.

28. The optical receiver of claim 17, wherein the gain control circuit is operative to provide feedforward control of an amplification gain.

29. An optoelectronic system comprising:
an optical detector for receiving an analog optical signal and generating an analog electrical signal;
an amplifier circuit connected to the optical detector for amplifying at least some portion of the analog electrical signal; and
a control circuit connected to the amplifier circuit for controlling the amplification of the amplifier circuit, wherein the control circuit comprises a linearity compensation component.

30. The optoelectronic system of claim 29, wherein the optical detector is operative to receive the analog optical signal and to generate the analog electrical signal having a power and wherein the control circuit is further operative to cause the amplification to increase if the power decreases.

31. The optoelectronic system of claim 29, wherein controlling the amplification of the amplifier circuit comprises controlling a gain of the amplifier circuit, and wherein the linearity compensation component causes the amplifier circuit to adjust the gain in a linear manner with respect to a gain control signal.

32. The optoelectronic system of claim 29, wherein the linearity compensation component is operative to facilitate a linear adjustment of the amplification in response to a change in the analog optical signal.

33. The optoelectronic system of claim 29, wherein the control circuit comprises a microcontroller.

34. The optoelectronic system of claim 29, further comprising an impedance mismatch between the amplifier circuit and the optical detector.

35. A circuit operative to receive optical signals broadcast over a fiber optic network and to output radio frequency electrical signals corresponding to the broadcast optical signals, the circuit comprising:
a photodiode;
an amplifier in communication with the photodiode, for amplifying modulated current from the photodiode;
a gain control circuit in communication with the amplifier, for controlling the amplifier; and
an impedance mismatch between the amplifier and the photodiode.

36. The circuit of claim 35, wherein the gain control circuit comprises a linear compensation component.

37. The circuit of claim 35, wherein the gain control circuit is in communication with the amplifier in a feedforward architecture.

38. The circuit of claim 35, wherein the gain control circuit comprises an input coupled to an output of the amplifier.

39. The circuit of claim 35, wherein the amplifier comprises two amplification stages.
